(19) United States
(12) Patent Application Publication
(10) Pub. No.: US 2001/0037247 A1
(43) Pub. Date: Nov. 1, 2001

(54) Method and system providing out-sourced, merchandise return services, and exchange and escrow services

(75) Inventor: Arthur S. Haseltine, Springfield, MO (US)

Correspondence Address: Jonathan A. Bay, Attorney at Law, Suite 314, 333 Park Central East, Springfield, MO, 65806, US

(73) Assignee: ENHANCE, INC.

(21) Appl. No.: 09/804,586

(22) Filed: Mar. 12, 2001

Related U.S. Application Data
(60) Provisional application No. 60/188,901, filed on Mar. 13, 2000.

(51) Int. Cl. G06G 1/14; G06F 17/60

(52) U.S. Cl. 705/22; 705/26

(57) ABSTRACT

A secured exchange method provides a prospective buyer with a chance to inspect the goods of a remote seller as a condition precedent to acceptance. The method is implemented by a distributed community of intermediary point-of-access associates who physically host such inspections, as well as by a managing inspection-transaction information service. The seller delivers the goods to one of the point-of-access associates, who in turn ships to another point-of-access associate, which is where the prospective buyer will inspect. There the prospective buyer gets the opportunity to inspect the offered goods and, upon buyer's application to accept, that particular point-of-access associate accesses the pertinent terms of acceptance from the managing inspection-transaction information service. If the pertinent terms of acceptance are met, the point-of-access associate releases the goods to the buyer.

### CROSS-REFERENCE TO RELATED AND PROVISIONAL APPLICATION(S)

This application claims the benefit of U.S. Provisional Patent Application No. 60/188,901, filed Mar. 13, 2000; and, U.S. patent application Ser. No. 09/731,680, filed on Dec. 6, 2000.

### BACKGROUND AND SUMMARY OF THE INVENTION

The invention generally relates to distributed computer systems and/or networks of interconnected computer systems, and more particularly to a method and system providing out-sourced, merchandise return service(s) which in substantial measure is implemented over such distributed computer systems and/or networks of interconnected computer systems.

A number of additional features and objects will be apparent in connection with the following discussion of preferred embodiments and examples.

The method and system in accordance with the invention is broadly advantageous for establishing an out-sourced merchandise return service. For convenience of terminology in this description, the party or business concern or receiving the out-sourcing business is termed the Service Bureau or at alternative other times, the Association Service. This service bureau predominantly is linked for communication by means of a computer-implemented server such as an Internet domain (for example, e-mail communication by an e-mail server) or even more preferably, a web domain (for example, web-page matter communication by a web domain). The party(ies) who are out-sourcing the merchandise return services may be referred to, needless to say, as merchandisers. More particularly, the profile of the representative merchandiser most likely to participate in this method of outsourcing return services includes the following characteristics.

The representative merchandiser is likely a retail merchandiser doing business by e-commerce. Indeed, some e-commerce merchandisers are likely transacting all of their business over the Internet/web. For others it might just be a majority, or even just some portion of their business. Nowadays there is a type of e-commerce merchandiser who offer(s) its goods in major part across the Internet and not as much by catalog sales or by brick-and-mortar retail stores. Put differently, its “e-commerce” business is highly valued even if it also conducts catalog sales or sells through brick-and-mortar stores. Retail merchandiser's who transact the predominant share of their business over the Internet are sometimes known as “e-tailers.” Again, “e-tailers” are reckoned as doing business-to-person e-commerce. A special class of e-tailers are the ones who essentially have no market presence other than their web store. Nowadays one of the largest and most recognized names among such e-tailers is AMAZON.COM®. But for every e-tailer the size of AMAZON.COM® or BARNESANDNOBLE.COM®, there are untold multitudes of others who are much more modest in size.

A problem facing all e-tailers, large and small, is the problem of merchandise returns. The following passage recites some aspects of the return problem for online merchandisers, particularly the specially focused e-tailers.

“Think about how often you receive unwanted presents. Sure, you appreciated the thought, but that hot-pink shirt from Aunt Thelma wouldn't have fit you even 15 pounds ago, and the color isn't remotely in your ‘palette.’ While returning the gift in the real world might mean waiting in long lines, the wait could be much more unpleasant online: You might not be able to return it at all.

“Consumers will spend at least $4.5 billion online this season, and of that, about 5 percent will be returned, estimates analyst Adam Sarner of the Gartner Group (IT) . . . .

“Web sites that don't allow consumers to return products to physical stores can certainly damage a brand's image, says Gartner's Sarner. A return can be ‘an opportunity for the store to sell another pair of pants, but they are basically turning customers away’ by not accepting the returns in person, he says.

“Most Web sites have some form of return policy, but it might not be the most ideal for consumers, Sarner says. Some Web sites allow customers to return products, but charge a 50 percent restocking fee to cover shipping and handling costs. ‘We saw a lot of that a couple of years ago, but it has gotten a lot better,’ Sarner adds. Now a handful of merchants are covering all return shipping costs, and even allowing customers to return online purchases to their stores. But the majority of sites still have a lot of work to do on their return processes.

“The retail industry traditionally works on thin margins, and may be unprepared for the challenges posed by returns. Some retailers have gone for the simplified approach of creating Web versions of their catalogs. Other merchants have spun their Web sites into separate subsidiaries, using incompatible technologies to manage inventory. The results are Web sites that function with primitive back-office processing.

“To get returns under control, you can either out-source them to a shipper like FEDEX® or a fulfillment house like FINGERHUT®, or handle them in-house, as NORDSTROM® (NOBE) does. Whichever model you choose, you need good systems and real-time information to pull it off . . . . ”

by Luisa Beltran, “Many Unhappy Returns” (Nov. 15, 1999), http://www.thestandard.com/article/display/0,1151,7458,00.html.

Framed in a different context, it is expected that the entry of WAL-MART® into e-commerce is going to adversely affect an e-tailer who competes on products head-to-head with WAL-MART®. To WAL-MART®'s advantage, it has a widely distributed infrastructure of brick-and-mortar stores. This facilitates more impulse buying than ecommerce. To WAL-MART®'s disadvantage, it has a widely distributed infrastructure of brick-and-mortar stores. These are no doubt costly to maintain. To the e-tailer's advantage, it has virtually no brick-and-mortar overhead and thus can offer goods at perhaps lower prices because of the virtual absence of such overhead. To the e-tailer's disadvantage, it has virtually no brick-and-mortar presence in a buyer's neighborhood. The absence of neighborliness aside, the e-tailer can't take back returns at the neighborhood outlet as say, WAL-MART® can.

What is needed is an improvement which addresses and overcomes the shortcomings of the prior art ways in which e-tailers can accomplish returns.

It is an object of the invention to establish a service for e-tailers in order to relieve such e-tailer's of the problem of returns, and do it highly cost effectively.

It is another object of the invention that the foregoing service operate in a manner likely to build goodwill with the purchasing public by virtue of a distributed network of point-of-return affiliates who will accept the e-tailer's returns on a walk-in basis in such associate's brick-and-mortar store. That is, the purchasing public ought to be pleased to carry out their returns of e-commerce purchases in stores in their own neighborhood.

It is an additional object of the invention that the above service and method of carrying out the returns include a compact token affixed to each product of each order fulfilled by an e-tailer, which token is encoded with packing-slip kinds of information. In a preferred embodiment, the token is preferably a point-of-fulfillment generated and affixed bar code.

It is an alternative object of the invention that the links of communication between the service, the e-tailers, and the point-of-return associates if not a wider public, be established on the Internet or the web for e-mail or web-page matter messaging and the like.

It is a further object of the invention that the above service provide various association services such as compilation of quality standards, menus of uniform return policies, train and certify point-of-return associates in the parameters governing obtaining authorization for return, and promoting the goodwill of the e-tailers who subscribe or associate with the service to their purchasing public.

These and other aspects and objects are provided according to the invention as will be apparent in connection with the following discussion of preferred embodiments and examples.

Among other aspects and objects, there are, briefly stated, a secured exchange facility of the service bureau. The secured exchange facility has some features of escrow, except that the objects entrusted with the service bureau point-of-access associates are shipped to and fro by permission of the parties. The secured exchange utility of the service bureau promotes more assurances for buyers that they will have more leverage with sellers in cases of non-acceptable items. The secured exchange utility of the service bureau ought to promote the interests of sellers by bringing in more potential buyers into the e-commerce market. That ought to be an advantage of the seller community. If the market of buyers is bigger, then on-average the market for the seller's item(s) ought to get a better price.

### BRIEF DESCRIPTION OF THE DRAWINGS

There are shown in the drawings certain exemplary embodiments of the invention as presently preferred. It should be understood that the invention is not limited to the embodiments disclosed as examples, and is capable of variation within the scope of the appended claims. In the drawings,

FIG. 1 is a schematic diagram showing a method and system in accordance with the invention for providing out-sourced, merchandise return services; and,

FIG. 2 is a schematic diagram showing the method and system in accordance with the invention as adapted for providing exchange and escrow services.

### DETAILED DESCRIPTION OF THE PREFERRED EMBODIMENTS

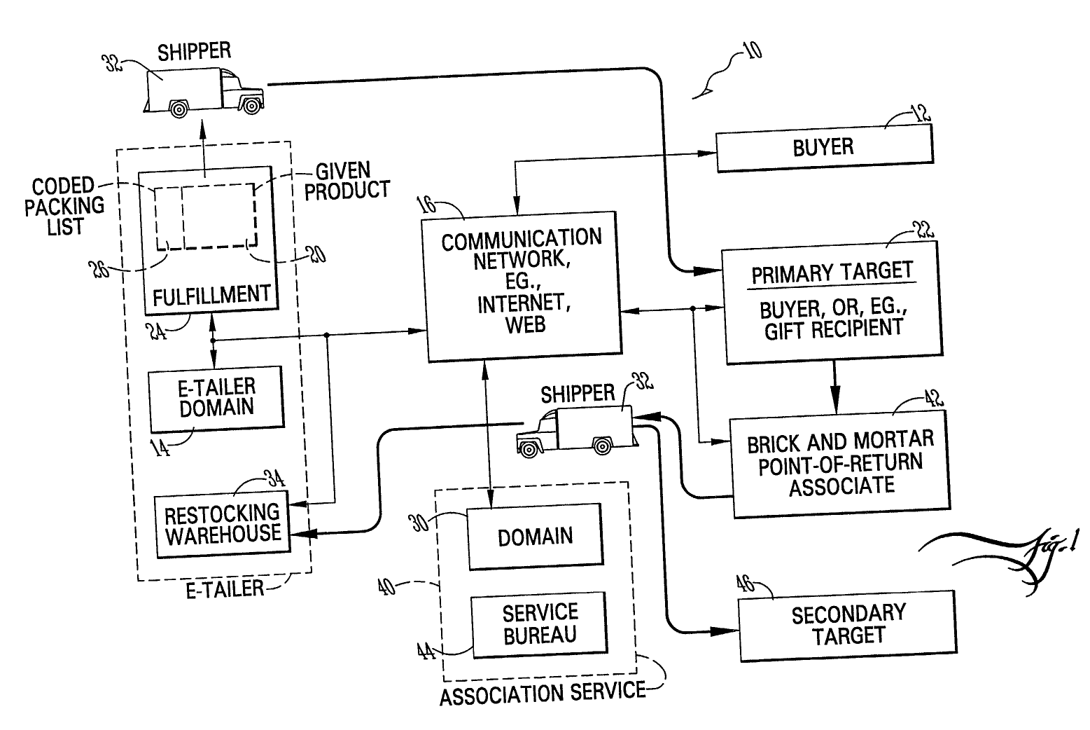

FIG. 1 shows a method and system 10 in accordance with the invention, for providing out-sourced, merchandise return services. FIG. 1 is highly simplified to show just the rudiments of a representative transaction in e-commerce, especially one where the recipient desires to return the received good(s). Aspects of this written description comprise an example to illustrate the diverse paths or routes taken by or available to not only the hardgoods but also the message information. However, the example is also simplified. Persons having routine skill in the art recognize that the variety of transactions which the invention can service can take multiple diverse other forms. Accordingly, the example is relied on merely for convenience in this description and does not limit the invention to this one example only.

A buyer 12 has communicated to the e-tailer domain 14 online vis-a-vis the Internet or World Wide Web 16 or the like. Presumptively, the buyer and e-tailer are geographically remote from each other. Of the two, the buyer is least likely to know where the e-tailer may be physically found. Indeed, the e-tailer may be spread around. Regardless, the buyer orders a given product 20 or a set of products. Buyer also designates the order to be shipped to what is referred to in the drawing as the primary target 22. Payment is customarily achieved by credit card as VISA® or MASTERCARD® or the like. The primary target can be the buyer itself, or else a recipient other than the buyer, for example a gift recipient. In the majority of such e-commerce transactions, the e-tailer and primary target are likely to be geographically remote from each other.

The e-tailer prepares (or has prepared) the order for shipment by what is called a fulfillment process 24. Some e-tailers do order fulfilment in-house, others also outsource order fulfillment responsibilities. During the fulfillment process, an inventive packing slip 26 is developed and applied to the given product. Preferably, the inventive packing slip comprises a point-of-fulfilment generated bar code. It might alternatively be an encoded magnetic strip. Such a bar-coded packing slip is affixed by any suitable means to as much of the product that preferably comprises a discrete, returnable unit. For example, if the returnable unit comprises a box of cookies, then it is the box and not the cookies which are affixed with the bar code. If on the other hand it is a carton of boxes, then it is the carton and not the individual boxes which are affixed with the bar code.

More significantly, if the discrete returnable unit is a garment, then preferably it is the garment to which the bar code is directly affixed. It is known by dry cleaning establishments to bar-code incoming laundry at point of intake. A paper sticker might suffice on some products, but something more durable might be needed on others. As mentioned with laundry, dry-cleaning establishments use an indelible dye applied directly to the garment or else an iron-on patch applied to the garment. The goal is to affix the code or bar code as tightly (eg., semi-permanently) to the product or its packaging as need be in order to deter persons from frustrating the method by switching tags. The inventive bar-coded packing slip is to be distinguished from the very familiar, bar-coded UPC code. The UPC code only gives information regarding the given product.

In accordance with the invention, the bar-coded packing slip shall yield much more specific information surrounding the transaction as a whole, including some of the following items. The accessible information might include any or all of the following, if not more:-eg., the identification of the e-tailer, the fulfillment service-provider, the shipper, the buyer, and the primary target; identification of the given product, which might be gotten by swiping (eg., reading) the UPC code thereon; a statement of the return policy of that e-tailer and more particularly with respect to that class of products; and so on. This might be achieved by encoding the foregoing information into a bar code having sufficient bandwidth to record the message.

Alternatively, the bar code might merely be an address to a record stored on some computer-implemented storage device somewhere. One object of the invention is to configure the association's server domain 30 to process requests to decipher such inventive bar-coded packing slips. For example, let's say that the fulfillment service provider wants to read the bar code to see if it printed properly. The fulfillment service provider could read the bar code by a reading device inter-connected to the device on which the record is stored. Alternatively, the fulfillment service provider could read the bar code, and then transmit the bar code either over an e-mail server or web server, as appropriate, the URL address encoded in the bar code would serve as a request to the association's server to respond with the packing list data for reading or browsing by the fulfillment service provider. In its turn, the association's server 30 may act as a router and pull the record off the e-tailer's site 14. Alternatively, the association's server might have the record stored with devices within its own domain.

By any of the foregoing scenarios, including routine variations thereon, the following is achieved. The fulfillment service provider 24 (eg., the requester) uses a swiping device to swipe the bar-coded packing list 26. The actual message read off the bar-coded packing list incorporates an address on the net or web, the submission of the actual message functioning like a request to view the packing list record, wherever that request may have to be routed. The destination of the request either directly or indirectly through requests of its own, sends or gets sent the packing list record to the requester. In this fashion, a relatively compact bar code can signify a voluminous mass of information which will greatly facilitate the return process, as more particularly described below.

To date, the given product has yet to clear the fulfillment service provider. The fulfillment service provider (which needless to say, may be the e-tailer itself) ships the order. Shipping is almost universally out-sourced to one of a few major nationwide if not international concerns. Progress continues, and the shipper 32 delivers the order to the primary target. Experience suggests that about ninety percent of the time (or so), the primary target keeps the order and attempts no return. The remaining other times, of course, the concern of the e-tailer is facilitating an authorized return to maintain goodwill but minimize if not eliminate the cost of such returns.

So, let's assume that the primary target wants to return the order, or at least a part thereof. For sake of convenience of an example, let's make the “given product” (for example, as so designated in FIG. 1) be what the primary target wants to return.

The primary target is one locale, but the e-tailer as well as the warehouse 34 the etailer will re-stock the return are located far away. Maybe the spread is a whole continent. It likely doesn't matter. The e-tailer is not likely to provide a walk-in service at its restocking warehouse 34.

Nevertheless, the primary target is informed by means of any various avenues of media that the e-tailer participates in an association 40 such that the e-tailer has a distributed network of point-of-return affiliates 42 who will accept the return on a walk-in basis. For example, the primary target may link to the service's web site and access a locator utility which finds, based on some input as zip code or the like, a nearby point-of-return associate. From the same page, links to web-page served maps will afford the primary target the ability to find driving directions. To turn to the point-of-return affiliates, such affiliates 42 might be the private mailing enterprises that dot the country. Although, it might turn out that the point-of-return affiliates work best if they come from a completely different industry than the private mailing enterprises. Indeed, it is believed that there will likely be competition by various brick-and-mortar stores to participate as such an affiliate for point-of-return association services. By doing so the brick-and-mortar stores gain for themselves increased customer traffic maybe not gotten by other means.

The point-of-return associate 42 provides walk-in processing of the primary target's request for return. The point-of-return associate reads or otherwise enters the immediate message given by the inventive bar-coded packing slip 26. Again, the immediate message might actually be a web request for the download of the more full record of the packing slip. However gotten, the point-of-return associate calls up the electronic packing slip. Unlike most paper packing slips seen nowadays, this inventive electronic packing slip includes precise information if not instructions to the point-of-return associate. Such information or instructions will guide this point-of-return associate on how to properly authorize the return of the given product of this e-tailer. The e-tailer might draft the criteria itself.

Assuming that the given item is passed for return, the instructions are further likely to tell the point-of-return associate (i) what to award to the individual bringing in the return, and (ii) what to do with the returned given item.

There are many options on what to award the individual bringing in the return. The options include (i) instant credit to the individual (regardless whether the actual buyer or not), (ii) credit to the buyer if different from the individual bringing in the return, or (iii) provisional credit, on the provision that the e-tailer certifies the propriety of the return once the e-tailer gets the given item back. The foregoing credits assume credit applicable with that e-tailer. Alternatively, another option might include (iv) credit with a broader community of merchants, perhaps every merchant and/or e-tailer who associates with or subscribes to the association's services. More basically, an alternative option could include (v) a direct refund, in cash or equivalent.

The next tack of the point-of-return associate is to route the returned item according to the instructions gotten by the packing slip. These instructions might come directly from the e-tailer. Alternatively, the instructions might have been composed by the service bureau 44. The instructions might be unchanged from the moment the bar-coded packing slip was created during the fulfillment process. More preferably, since the instructions are likely to be downloaded over the Internet or web, then this affords the e-tailer, the service bureau, or both in cooperation with each other, to dynamically update the downloadable instruction set depending on changed circumstances.

For example, the instructions might be relatively unchanging:—eg., “Ship back via such-and-such shipper to re-stocking warehouse, always.” On the other hand, the downloadable instruction set might be perpetually in flux. One morning a given point-of-return associate might ship away a given item of a given retailer back to that e-tailer's customary re-stocking warehouse 34. That afternoon, the same point-of-return associate 42 might be instructed to ship away to the same given item of the very same given e-tailer, to a completely different destination.

This will be illustrated with an example. Let's say one child got for the holidays three (3) identical copies of the latest, faddiest POKEMON® game toy, each one purchased from one e-tailer or another. Assume also that the givers of the gifts for this child acted early, and got these copies before the supply was exhausted for much of the rest of the public. Given the foregoing, our example child has brought in the two spare copies of the POKEMON® game toy to the neighborhood point-of-return associate, in Racine, Wisconsin. The downloaded instructions say—rather than send back to the e-tailer's restocking warehouse in Los Angeles, do the following:—if the condition of the returned POKEMON® game toy meets given criteria, then (i) re-affix to the returned POKEMON® game toy a new bar-coded packing list as provided to, eg., the point-of-return associate's web browser, and (ii) forward ship this POKEMON® game toy to another child in say, Madison, Wis.

In FIG. 1, this other child in (eg.) Madison, Wisconsin, is designated the secondary target 46.

The point of the foregoing example is the following. In cases of some returned items, it might be possible to have the point-of-return associate re-distribute the item to a more nearby secondary target, then ship it back to a far away re-stocking warehouse. The re-stocking warehouse might simply forward ship it to the secondary target anyway. But by the method in accordance with the invention, the action taken by the point-of-return associate to ship directly to the secondary target (when the condition of the returned item is sufficiently excellent to permit this) provides a twofold savings for the e-tailer. One, it saved the e-tailer the costs of two cross-country shipments for the price of one local shipping. And two, it got the secondary target its hoped for product much sooner. No doubt, some ideas stay in fashion regardless of the Internet, and speedy delivery is always fashionable and pleasing to the public.

With reference again to FIG. 1, the service bureau 44 best services its populous community of e-tailers (eg., 14) and brick-of-mortar point-of-return associates 42 with a variety of association services. For instance, the service bureau might compile a set of quality standards on about every aspect of the operation. The quality standards might insist that the point-of-return associates provide a clean and accessible store. That customer handling is speedy and affable. The point-of-return associates might be educated in diplomatic ways of handling irate customers, and not further fueling the angst. In respect of the e-tailers, they too must meet standards so that one or a few might not drag down the reputation of the community as a whole. Hence, the e-tailers are likely to be persuaded to the wisdom of a relatively relaxed return policy. If the criteria by which returns will be accepted is too stringent, then perhaps every customer attempting a return is going to be disappointed. To inform the public that there is an association and apparatus set up to facilitate returns, when in fact returns are seldom granted, is more likely to damage goodwill than to either build goodwill or just prevent its loss. Therefore, the return policies of the various e-tailers have to be in fact real and not illusory.

Indeed, another role for the service bureau 44 is to draft a short list of uniform return policies. The draft return policies are available for adoption by the e-tailers. Indeed the e-tailers likely would be induced to adopt a return policy from the association's menu. The purpose behind keeping the variety of return policies down to a few makes sense with the point-of-return associates. They ought to be so familiar with each one of the return policies on the menu that they can instantly act on any policy before a customer and apply the return policy accurately. The purpose behind keeping the different available return policies uniform serves a lot of the same reasons. The point-of-return associates ought not have to read and study a closely written legal document in order to facilitate a simple return. It will bog down the return service, and be un-popular with both customers and point-of-return associates. Of course, one of the association's persistent tasks is finding balance between what effectively serves the e-tailer community against what effectively serves the point-of-return associate community.

An additional role of the association 40 and/or 42 is to provide training if not certification for point-of-return associates. The point-of-return associates will likely have to add some hardware to their enterprise. Among the things they will need to have and need to know how to use include a portal to the Internet, a bar-code reading device (or like device for reading the electronic packing list), and packing and shipping accessories. The training will also include customer relations as well as training in the technical matters of the return policies, what the return policies call for, and how to ensure that the respective e-tailer will honor the obligation to which the point-of-return associate is committing it.

A further role of the association 40 includes promoting the goodwill of the e-tailers who subscribe or associate with the service to their purchasing public. This likely includes advertising for the network of point-of-return associates. Further association services might include construction of regional re-stocking warehouses available only for the goods of e-tailers participating in the association. Also, the association might set up a financial services sub-service to facilitate multiple aspects of the operation. For example, any credit given to anybody might be honored by any member e-tailer of the association. Also, the financial services sub-service might pay the shippers on behalf of the submissions of the point-of-return associates, and then bill the applicable e-tailers afterwards.

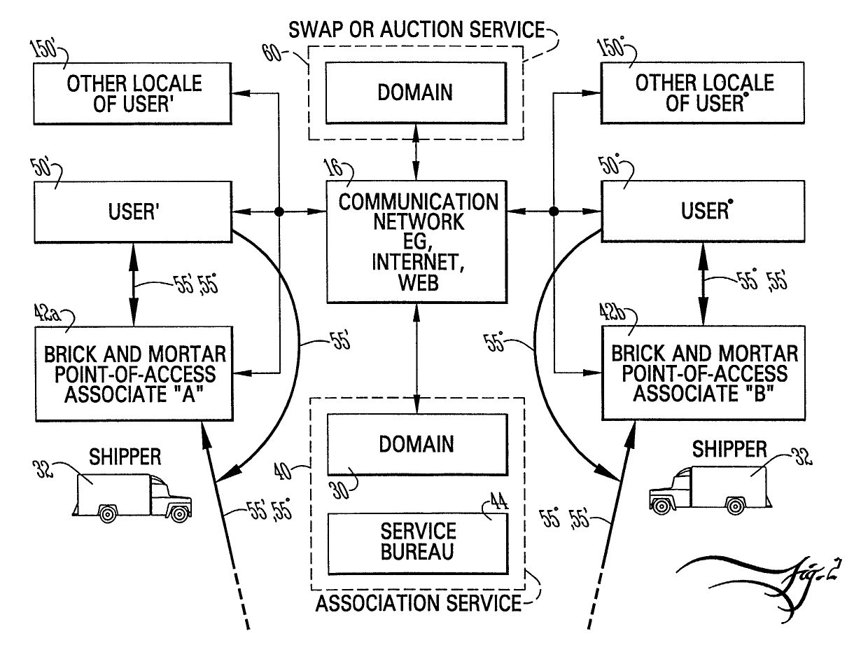

Pause can be taken at this stage to consider other flexible advantages that can be provided by the affiliation between the association service 40 and its distributed brick-and-mortar associates 42. These other aspects and advantages are shown in part by FIG. 2.

With reference to FIG. 2, it shows the association service 40 in combination with at least two others of its community of brick-and-mortar associates, eg., associate “A” 42a and associate “B” 42b. The utilization of the association service 40 in combination with the brick-and-mortar associates 42a, 42b et seq. (FIG. 2 only showing 42a and 42b) can be adapted for facilitating long-distance transfer of goods and things in transactions of all kinds of configurations.

Such transactions include a buyer-vendor transaction, which may be modified secured exchange services as described more particularly below. Other transaction configurations include delivery of goods or things between a buyer and seller, the sale of which was facilitated on an Internet auction site such as E-BAY® or the like. Still other transactions might be exchanges of goods or things such as barters or swaps, which are more and more these days being facilitated by web sites of all kinds of variety.

Thus, considering first a buyer-vendor transaction, the association service can be utilized as follows for various advantages which will readily become more apparent. In FIG. 2, the seller can be taken as one user 50¹ while the buyer can be taken as the other user 50⁰. The seller 50¹ and buyer 50⁰ have agreed that buyer 50⁰ will buy seller 50¹'s item 55¹ for payment. They agree to use the secured exchange facility of the service 40. The secured exchange facility works this way. The seller 50¹ finds its preferred point-of-access associate 42, which in FIG. 2 is associate “A” 42a, and duly deposits the item 55¹ with point-of-access associate “A” 42a. Point-of-access associate “A” 42a merely holds the item at this stage. Perhaps the seller 50¹ was required to pre-pay shipping or a service fee, or otherwise have an account which will cover fees (if any) which might be owed by the seller/item-depositor 50¹ depending on the various possible outcomes which might play out from this stage.

Next, the seller 50¹ might contact buyer 50⁰ or cause point-of-access associate “A” 42a to contact buyer 50⁰ with a message that the item 55¹ has been entrusted in possession with a given point-of-access associate 42 (ie., 42a in this instance) of the service 40. Such message is preferably sent over the Internet in either e-mail or web format or the like. The buyer 50⁰ has several options available to it to cause the shipping of the item. The buyer 50⁰ can pay the seller 50¹ directly. More preferred is if the buyer 50¹ pays the service 40 or else pays a point-of-access associate 42 which the buyer 50⁰ finds nearby, which in FIG. 2 is associate “B” 42b. This secured exchange facility of the service 40 provides the buyer 50⁰ with inventive aspects described more particularly next if the buyer 50⁰ designates its preferred point-of-access associate 42 (eg., 42b) to receive the item 55¹ from associate 42a. If buyer 50⁰ has paid (as verified by seller 50¹ or service 40) and makes such a designation, associate “A” ships to associate “B.” When the item 55¹ is received by associate “B” 42b, the buyer can visit point-of-access associate “B” 42b and inspect the item there. The buyer 50⁰ can refuse or pick-up the item 55¹ in its own discretion. If item 55¹ is refused, the seller 50¹ is notified. If the item 55¹ is taken, then the service 40 releases or causes release of payment to the seller 50¹.

Briefly stated, the inventive aspect of this secured exchange facility of the service 40 is the way a buyer/receiving-user 50⁰ is afforded an opportunity to refuse the item 55¹ once the buyer 50⁰ has a chance to inspect. The service 40 plays an intermediary role which serves the buyer 50⁰ and seller 50¹ in these ways. The buyer 50⁰ is afforded an opportunity to inspect the item 55¹ before taking possession without the seller 50¹ already having gotten the payment. Hence the buyer 501 is in a better position to work out the problems with the seller 501 if the seller 50¹ hasn't already been paid. For the seller 50¹, the secured exchange facility of the service 40 is likely to attract more buyers to doing business this way, and buy from the seller 50¹, which buyers might otherwise be reluctant to buy.

The secured exchange facility of the service 40 can be compared to C.O.D., except that shipping from point “A” 42a never transpires until the buyer 50⁰ pays, or if not actually pays then otherwise secures payment in some chargeable fashion under the control of the service 40. For instance, the buyer 50⁰ might have to give advance authorization to a credit card charge or the like. Thus for the seller 50¹, the secured exchange facility of the service 40 is preferable over C.O.D. because the item was never shipped from point “A” 42a.

Other details of the transaction can be varied by the parties or settled by the Uniform Commercial Code laws. Such other details include:—who pays the shipping; who pays the fees of the service 40 and its point-of-access associates 42; whether the service 40 requires one or both of the buyer 50⁰ and seller 50¹ to pre-pay in full of part or else offer a chargeable account with the service 40 so that the service 40 is not overly exposed to incurring loss for transactions gone awry; what remedies the seller 50¹ has against the buyer 50⁰ for wrongful refusal and so on.

The manner of use of the foregoing secured exchange process may be modified as follows. With renewed reference to FIG. 2, again the seller 50¹ and buyer 50⁰ have agreed that buyer 50⁰ will buy seller 50¹'s item 55¹ for payment. They agree to use the secured exchange facility of the service 40 by this following manner of use. The seller 50¹ bypasses point-of-access associate “A” 42a, and instead ships the item 55¹ to point-of-access associate “B” 42b which is proximate the buyer 500. Point-of-access associate “B” a merely holds the item at this stage. Although the seller 50¹ likely pre-paid the shipping fee, the seller 50¹ would preferably have an account with the service 40 or an open charge on a credit card or the like which will cover fees (if any) which might be owed by the seller/item-depositor 50¹ depending on if the buyer 50⁰ refuses the item 551.

Next, the seller 50¹ might contact buyer 50⁰ or cause point-of-access associate “B” 42b to contact buyer 50⁰ with a message that the item 55¹ shall soon arrive at and/or will be entrusted in possession with point-of-access associate “B” 42b of the service 40. Such message is preferably sent over the Internet in either e-mail or web format or the like.

As a condition precedent to shipping, the seller 50¹ may have required the buyer 50⁰ to pre-pay or place a deposit. Whereas the buyer 50⁰ might agree to pay the seller 50¹ directly, more preferred is if the buyer 50¹ pays the service 40 or else pays a point-of-access associate 42 which the buyer 50⁰ finds nearby, which in FIG. 2 is associate “B” 42b. Here again the service 40 is providing services in the nature of escrow by holding buyer's payment until buyer is afforded an opportunity to inspect item 55¹ at the agreed upon point-of-access associate 42 (eg., 42b). When the item 55¹ is received by associate “B” 42b, the buyer can visit point-of-access 42b and inspect the item 55¹ there. The buyer 50⁰ can refuse or pick-up the item 55¹ in its own discretion. If item 55¹ is refused, the seller 50¹ is notified. If the item 55¹ is taken, then the service 40 releases or causes release of payment to the seller 50¹.

As before, other details of the transaction can be varied by the parties or settled by the Uniform Commercial Code laws. Such other details include:—who pays the shipping; who pays the fees of the service 40 and its point-of-access associates 42; whether the service 40 requires one or both of the buyer 50⁰ and seller 50¹ to pre-pay in full of part or else offer a chargeable account with the service 40 so that the service 40 is not overly exposed to incurring loss for transactions gone awry; what remedies the seller 50¹ has against the buyer 50⁰ for wrongful refusal and so on.

Whereas the foregoing manners of use of the service 40's secured exchange facility serves a long-standing general need between buyers and sellers, it more particularly ensures more trustworthy transactions given today's Internet auction and swap sites. FIG. 2 shows a generic Internet auction and swap site. One of the more popular ones of such sites surely includes E-BAY®, for example. On such an auction site, an offeror offers its item for sale to others, who when they buy usually have no opportunity to evaluate the item except from the offeror's description and perhaps some scanned-in images. While perhaps only a small fraction, there are buyers who are finding themselves disappointed if not close to being deceived once they get their items. Getting the offeror to take back the item in these cases is a practical impossibility, short of a lawsuit. And the offeror no doubt has its own side of the story to tell also. In any event, some of these disappointed buyers, once bitten, shy away from doing much more business in the e-commerce arena.

The secured exchange utility of the service 40 promotes more assurances for the buyer 50⁰ that it gets at least some inspection for the item 55¹ without having to be out all of its payment. The secured exchange utility of the service 40 ought to bring in (or bring back) more potential buyers into the e-commerce market to the advantage of the seller community. If the market of buyers is bigger, then on-average market for the seller's item(s) ought to get a better price.

It may be noted that, if a buyer 50⁰ wrongly refuses pick-up at point “B” 42b, and the buyer 50⁰ transacted with the seller 50¹ as an original matter through the swap or auction site 60, the seller's remedies for wrongful refusal might also be covered by policies of the swap or auction site 60. This would provide an additional layer of remedies for the seller 50¹, in addition to the Uniform Commercial Code and so on. The service 40 has the option of providing its own layer(s) of buyer/seller remedies or alternative resolution processes.

A further utilization of the secured exchange facility of the service 40 accommodates swap transactions, or barters or exchanges. This time around, FIG. 2 can be reckoned as showing one user 50¹ entrusting one item 55¹ with point-of-access associate “A” 42a. Another user 50⁰ is shown entrusting another item 55⁰ with point-of-access associate “B” 42b. When both parties 50¹ and 50⁰ have completed the deposit of their respective items 55¹ and 55⁰, then upon proper notification presumptively verified by the service 40, the associates 42a and 42b cross-ship the items 55¹ and 55⁰. Here again, each recipient user 501 and 50⁰ gets to inspect the incoming item 55⁰ and 55¹ respectively, with some chance to refuse acceptance.

The rules of pick-up can be structured in various ways. The pick-ups of each party 50¹ and 50¹ can be arranged to occur concurrently, such that the point-of-access associates 42 retain possession until each party 50¹ and 50⁰ accepts. Or else, one party may be the earlier party to visit its point-of-access associate 42 and give notification of acceptance, but leave without possession of the item. Then the later party gets the convenience of visiting its point-of-access associate 42 and not only giving notification of acceptance, but also taking possession of the item. That way, the earlier party has to re-visit its point-of-access associate 42 a second time to take possession. Alternatively, the earlier party to visit its point-of-access associate 42 and give notification of acceptance may be allowed to leave with possession of the item, provided it also provides security or buys insurance and the like.

An additional variation includes the following. By way of background, various objects of the invention are met when the one user 50¹ gets its item 55¹ to the point-of-access associate “B” 42b relatively proximate the other user 50⁰ while the other user 50⁰ achieves getting its item 55⁰ to the point-of-access associate “A” 42a relatively proximate the one user 50¹. Needless to say, this can be accomplished as also shown by FIG. 2. That is, one or both the users 50¹ and/or 50⁰ may ship directly to the respective point-of-access associate 42b or 42a that is proximate the opposite party 50⁰ or 50¹, respectively. Again, either user 50¹ or 50⁰ can entrust its respective item 55¹ or 55⁰ with the service 40's process of secured exchange by either way. That is, either by supplying or shipping the item 55 to one point-of-access associate 42a which then relays the item to another point-of-access associate 42b relatively close to the opposite party, or else by undertaking the shipping all on one's own accord and shipping the item 55 to such other point-of-access associate 42b which happens to be relatively close to the opposite party.

As mentioned previously, the secured exchange facility of the association 40 provides enhanced trustworthiness between barter exchanging parties who have no real history dealing with each other or otherwise having a good opportunity to evaluate the other's item. It is an object of the secured exchange facility of the association 40 to provide greater comfort between parties 50⁰ and 50¹ that each is not totally reliant on the kindness of strangers making such swaps take place to the pleasure of both.

FIG. 2 has assumed a very simple swap arrangement. The swap arrangement might have further complexities including some of the following. The swap might take place in a three way exchange. Or else, the point-of-access 42 used by any party 50¹ or 50¹ need not be the same for depositing its own item and picking up the incoming item. Indeed, the one party 50¹ might be reckoned as an organization having an available item at one locale 150¹ which it is willing to swap for an incoming item to be picked up at the original locale 50¹, and so on, the same being true for the other party 50⁰ and 150⁰. Presumptively, each of the alternate locales 150¹ and 150⁰ find respective point-of-access associates 42 (these other point-of-access associates 42 are not shown in FIG. 2) to deal with at their convenience.

The secured exchange facility of the service 40 can be modified by varying rules-of-the-service, as follows. Assume sender 50¹ agrees to send item 55¹ to receiver 50⁰ either for payment or exchange of item 55⁰, it not mattering which for the moment. After the agreement has been reached between the parties 50¹ and 50⁰, the use of the service 40 can work this way. The chosen point-of-access associate 42a of sender 50¹ is given a description of the item-to-be-sent 55¹, which description presumptively conforms to an acceptable model format established by the service bureau 44. A clerk of point-of-access associate 42a is authorized to use the description, which description is either given to the clerk in a certified form by the sender 50¹ or else downloaded from the service 40's web site 30, to use to make the following determination. That is, the clerk makes a determination if the item 55¹ is reasonably what it should be. The clerk's determination may be binding on the receiver 50⁰ to perform as obliged (eg., pay if payment was agreed upon), or else provisionally binding on the receiver to perform at least in part as obliged. Performance in part might include having the receiver 50⁰ pay in part (eg., to at least cover one-way or round-trip shipping plus a fee) else deposit its swap item 55⁰ with its chosen point-of-access associate 42b.

The invention having been disclosed in connection with the foregoing variations and examples, additional variations will now be apparent to persons skilled in the art. The invention is not intended to be limited to the variations specifically mentioned, and accordingly reference should be made to the appended claims rather than the foregoing discussion of preferred examples, to assess the scope of the invention in which exclusive rights are claimed.

I claim:

1. A merchandise inspection system for a remote seller and prospective buyer comprising:
a service providing the remote seller and prospective buyer with merchandise-inspection information services, comprising merchandise-inspection information storage means for storing merchandise-inspection information applicable to merchandise of the seller;
a distributed community of point-of-access associates, linked to the merchandise-inspection information storage means by a communications medium, for physically processing inspections by the prospective buyer of the seller's merchandise submitted to a given point-of-access associate if authorized after application to the merchandise-inspection information storage means; whereby the prospective buyer may refuse the inspected merchandise in consequence of the inspection.

2. The merchandise inspection system of claim 1 wherein:
the merchandise-inspection information stored on the storage means includes information on particular conditions of release by the given point-of-access associate of the inspected merchandise to the prospective buyer.

3. The merchandise inspection system of claim 2 wherein particular conditions of release by the given point-of-access associate of the inspected merchandise to the prospective buyer include verification that the prospective buyer sufficiently fulfills or secures payment or barter for the inspected merchandise.

4. The merchandise inspection system of claim 2 further comprising:
merchandise identifiers associated with the merchandise before or concurrent with the seller's submission of the merchandise to the given point-of-access associate wherein the identifiers facilitate research of information in the merchandise-inspection information storage means.

5. The merchandise inspection system of claim 1 further comprising a plurality of remote sellers who transact with the merchandise inspection information service and who deal in a wide variety of differing goods, wherein the distributed community of point-of-access associates generally provide retail mail, parcel and shipping services generally not directly competitive with the goods of the sellers.

6. The merchandise inspection system of claim 1 wherein the service and at least some of the distributed community of point-of-access associates are part of a common organization.

7. A method providing a prospective acceptor an opportunity to inspect the offered goods of a remote offeror as a condition precedent to acceptance, comprising the steps of:
providing the offeror and prospective acceptor with a goods-inspection information service, including storage of inspection and terms-of-acceptance information pertaining to the offered goods of the offeror;
providing a distributed community of point-of-access associates who can physically process such inspections with links to the goods-inspection information service by a communications medium;
the offeror entrusting the offered goods to a given point-of-access associate and thereby affording the acceptor the condition-precedent opportunity to inspect the offered goods;
the given point-of-access associate providing the prospective acceptor with the opportunity to inspect the offered goods upon application to inspect; and, upon further application to accept, the given point-of-access associate requesting from the goods-inspection information service the pertinent inspection and terms-of-acceptance information, and then processing the acceptance of the offered goods if the pertinent terms of acceptance are met.

8. The goods inspection method of claim 7 wherein the pertinent inspection information includes disposition information in cases of refusal or failure to act timely to inspect.

9. The goods inspection method of claim 7 wherein the pertinent inspection and terms-of-acceptance information includes information on how given point-of-access associate should confirm if the acceptor sufficiently meets pre-scribed terms of payment or barter, if any.

10. The goods inspection method of claim 7 further comprising:
providing goods identifiers for attachment to the offered goods before or concurrent with the offeror entrusting the offered goods to the given point-of-access associate, wherein the identifiers facilitate the information service's research when servicing information requests.

11. The goods inspection method of claim 7 wherein the communications medium comprises the Internet global computer information network.

12. The goods inspection method of claim 7 further comprising the offeror inputting the offered goods with an arbitrary different one of the point-of-access associates who in consequence transmits the inputted goods to the given the point-of-access associate where the prospective acceptor may inspect.

13. The goods inspection method of claim 12 wherein the offeror inputs the pertinent inspection and terms-of-acceptance information concurrently with inputting the offered goods.

14. A method providing a prospective acceptor an opportunity to inspect an offered item of a remote offeror as a condition precedent to acceptance, comprising the steps of:
providing a distributed community of intermediary point-of-access associates for physically hosting such inspections;
a remote offeror of an item offering a prospective acceptor the item for acceptance upon condition precedent of an inspection of the offered item;
the offeror inputting the item with an arbitrary one of the point-of-access associates who in consequence transfers the item to a given other of the point-of-access associates where the prospective acceptor will inspect;
providing the distributed community of intermediary point-of-access associates with links to an inspection-transaction information service by the Internet computer information network;
the offeror inputting with the inspection-transaction information service the terms of acceptance of the offered item;
the given other point-of-access associate providing the prospective acceptor with the opportunity to inspect the offered item upon application to inspect; and, upon further application to accept, the given other point-of-access associate requesting from the inspection-transaction information service the pertinent terms of acceptance, and then processing the acceptance of the offered goods if the pertinent terms of acceptance are met.

15. The goods inspection method of claim 14 wherein the terms of acceptance include payment or barter terms.

16. The goods inspection method of claim 14 further comprising in case of refusal by the prospective acceptor to timely inspect or accept after inspection, the inspection-transaction information service providing disposition information regarding the item.

17. The goods inspection method of claim 14 further comprising:
the seller providing security for covering the cost of disposition of the item in case of refusal by the prospective acceptor to timely inspect or accept after inspection, which security may be inputted with any one of the point-of-access parties or the inspection-transaction information service, including the arbitrary one of the point-of-access parties at the time of inputting the item.

18. The goods inspection method of claim 14 further comprising:
the prospective acceptor providing security for covering the cost of disposition of the item in case of refusal by the prospective acceptor to timely inspect or accept after inspection, which security may be inputted with the given other of the point-of-access associates, any different others of the point-of-access associates, or the inspection-transaction information service.

19. The goods inspection method of claim 14 further comprising either the inspection-transaction information service or the community of point-of-access associates, including solely the given other point-of-access associate, originating contact with the prospective acceptor upon the readiness of the given item for inspection.

20. The goods inspection method of claim 19 wherein either the offeror, the inspection-transaction information service or the community of point-of-access associates monitors the lapse of time and follow-up contacts with the prospective acceptor, if any, since the original contact in order to decide whether the prospective acceptor constructively refuses by reason of failure to act timely to inspect.
